(19) United States
(12) Patent Application Publication
(10) Pub. No.: US 2022/0040723 A1
(43) Pub. Date: Feb. 10, 2022

(54) DECORATIVE WATER FOUNTAIN FOR POTTED PLANTS

(71) Applicant: Daniel Michael Stewart, Ben Lomond, CA (US)

(72) Inventor: Daniel Michael Stewart, Ben Lomond, CA (US)

(21) Appl. No.: 17/395,349

(22) Filed: Aug. 5, 2021

Related U.S. Application Data
(60) Provisional application No. 63/061,401, filed on Aug. 5, 2020.

(51) Int. Cl. B05B 17/08

(52) U.S. Cl. CPC B05B 17/08

(57) ABSTRACT

In one aspect, this disclosure is related to a universal decorative water feature for use in potted plants. The decorative water feature, in the form of a fountain, is provided as a singular standalone device provided in an assembly. The water feature includes a bucket having sidewalls defining an interior space configured to hold water provide structure for the placement and attachment of additional components. Accordingly, the bucket upper side includes a lip for the placement of a screen cover, generally including a plurality of apertures to allow for the flow of water from an exterior of the screen cover to the interior of the bucket. The assembly including a submersible pump coupled to a power source, a valve handle that is accessible to a user at an exterior of the device, a water tube in communication with the valve handle, and at least one ornamental feature.

### CROSS-REFERENCE TO RELATED APPLICATION

This U.S. patent application patent application claims priority to U.S. Provisional Application 63/061,401 filed Aug. 5, 2020, the disclosure of which is considered part of the disclosure of this application and is hereby incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

This invention relates generally to a water fountain assembly. In one aspect, the disclosure relates to a water fountain configured for use with and within potted plants.

### BACKGROUND

It is known that water fountains are a desirable to addition to any landscape or living space. A general fountain assembly is placed within a container of water and utilizes a pump to circulate and re-circulate water into a plume or flow of water in a decorative appearance. Often these water fountains are provided as an assembly for a variety of uses, such as, but not limited to, landscape decorations, bird baths, and statutes. Often, when used in these settings, these types of fountains are placed in areas where they can become dirty and need to be regularly cleaned.

Still other fountain assemblies are provided as a kit configured for installation into the ground or pond with the kit generally including a pump member, hose, and spigot generally configured to direct water. Most generally, these fountains are operated by providing power to the pump to circulate water from a reservoir through the pump to the spigot and back to the reservoir.

There exists a need for a more compact and universal fountain assembly. Preferably, this assembly is configured for use in potted plants and configured for universal use, wherein the fountain assembly can utilized as a stand-alone structure for placement as a singular water feature in the potted plants.

### BRIEF SUMMARY OF THE INVENTION

In one aspect, this disclosure is related to a universal decorative water feature for use in potted plants.

In another aspect, this disclosure is related to a decorative water feature in the form of a water fountain assembly most generally comprising a submersible pump coupled to a power source, a screen cover, a valve handle that is accessible to a user at an exterior of the device, a water tube in communication with the valve handle, at least one ornamental feature, and a collection bucket positioned below the screen cover and having a size for receipt of the submersible pump.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a perspective view of the device, according to the present disclosure;

FIG. 2 shows a side view of the device, according to the present disclosure;

FIG. 3 shows a bottom view of the device, according to the present disclosure;

FIG. 4 shows a top view of the device, according to the present disclosure; and

FIG. 5 shows an exploded view of the device according to the present disclosure. right side of the device

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The device of the present disclosure is most generally configured as decorative water featured configured for placement into a potted plant. The device is configured as a standalone unit with the assembly and device components substantially housed within a single unit.

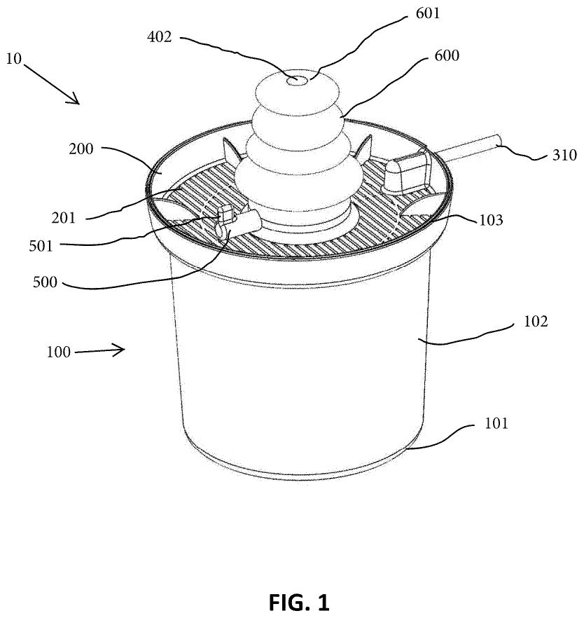

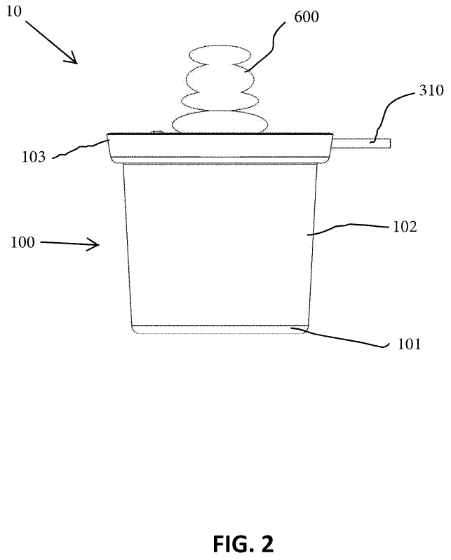

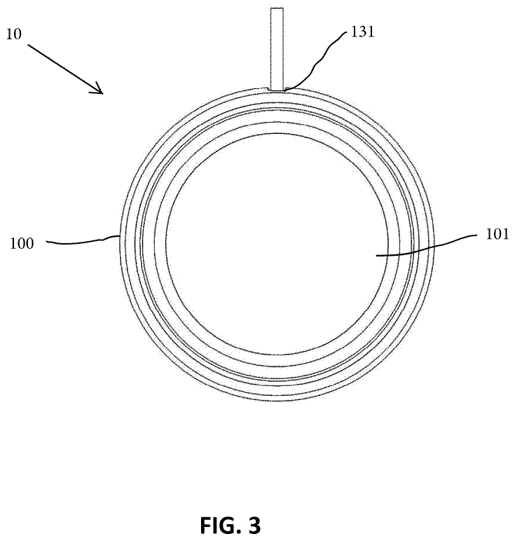

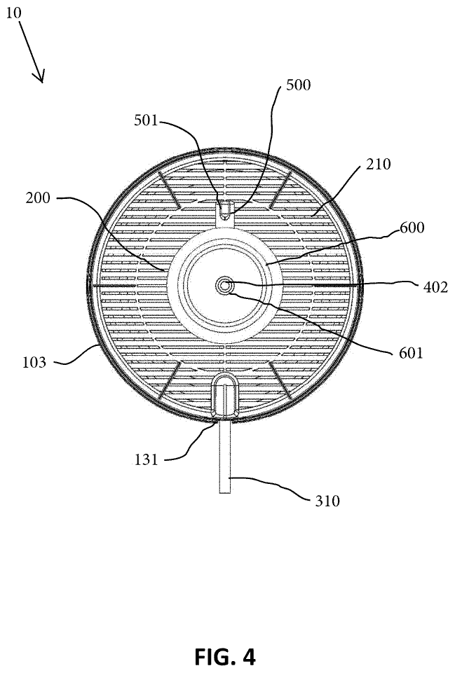

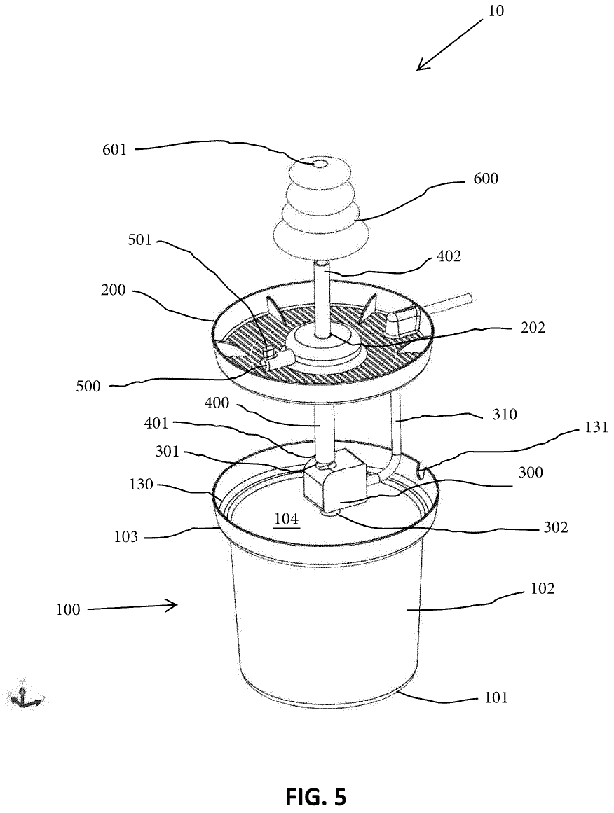

Referring now to the figures, FIG. 1-FIG. 5 of the present disclosure of the decorative water fountain for potted plants generally referred to as device 10. The device 10 is configured for placement within a potted plant to provide a pleasant decorative water feature. The device 10 could be most generally described as a standalone fountain unit. The device 10 can be further described as an assembly of a plurality of features in a coupling to form a cohesive device 10 in a single unit.

The device 10 single unit assembly comprising a collection bucket 100 generally forming a housing and structure for the enclosure and support of the additional items of the device 10. The collection bucket 100 having a bottom side 101, sidewalls 102 in communication with the bottom side 101 extending a height of the collection bucket 100 with the sidewalls 102 culminating in an upper side 103. The collection bucket 100 bottom side 101, sidewalls 102, and upper side 103 forming a waterproof cavity 104 with an interior dimension configured to retain a fluid, such as, but not limited to, water. In the preferred assembly, the collection bucket 100 is generally frustoconical in shape with tapered sidewalls 102 extending from the bottom side to the upper side 103, wherein the bottom side 101 has a smaller diameter than the upper side 103 of the frustoconical shape of the collection bucket 100. The frustoconical shape of the bucket 100 generally having shape resembling a pot the device 10 is placed within.

The upper side 103 of the bucket 100 including a lip 130 generally extending a circumference encompassing the entirety of the upper side 103. The lip 130 generally presenting a flattened surface inward from the sidewalls 102 opposite an exterior of the bucket 100. The lip 130 surface configured with a size and shape to provide resting support for a screen cover 200. The upper side 103 further including a notch 131. The notch 131 providing an access to the interior 104 of the bucket 100 from the exterior for a power cable 310 coupled to the pump 300.

The screen cover 200 generally having a size and shape configured for receipt on the upper side 103. The screen cover 200 including a plurality of apertures 201 in the form of a grated assembly to enable a flow of water from an upper area of the screen cover 200 to the interior cavity 104, wherein the screen cover 200 provides a fluid permeable resting surface at the upper side 103 of the bucket 100. The grated assembly of the screen cover 200 generally configured with a grate size through the plurality of apertures 201 to enable placement of a material, such as, but not limited to, gravel, small rocks, beads, pebbles, glass pieces, plants or other similar material with sufficient gaps to enable flow of the fluid over the material and back into bucket 100. The screen cover 200 including a central aperture 202 enabling access from the interior 104 of the bucket 100 to the exterior of the screen cover 200 and having a size and shape for receipt of a fluid transfer tube 400.

The pump 300 generally of the submersible variety, wherein the pump 300 is coupled to a power source through the power cable 310. The pump 300 configured for placement under the surface of a fluid and resting on the bottom side 101 of the bucket 100. The pump 300 having an outlet 301. The outlet 301 configured to direct fluid leaving the pump 300 into the fluid transfer tube 400. Alternately, the pump 300 may include an attachment surface 302, such as, but not limited to, a suction cup for securing the pump 300 on the bottom side of the bucket 100.

The fluid transfer tube 400 having a first end 401 opposite a second end 402 with a distance between the first end 401 and the second end 402 defining a length of the tube 400. The first end 401 configured for a secure coupling to the pump 300 outlet 301, wherein fluid moved by the pump 300 though the outlet 301 is translated into the tube 400. The second end 402 of the tube 400 extending through the central aperture 202 exterior to the screen cover 200 and culminating as the exit point for fluid transferred through the tube 400. The flow of fluid from the pump 300 outlet 301 within the tube 400 regulated through a coupling with a valve 500.

The valve 500 in fluid coupling with the tube 400 to regulate the flow of fluid within tube 400. The valve 500 positioned at the exterior of the bucket 100 on an upper side of the screen cover 200 opposite the interior cavity 104. The valve 500 including a handle 501 configured to enable a user to manipulate the valve 500 between an open position enabling flow within the tube 400 and a closed position wherein fluid within the tube 400 is not capable of exiting the second end 402. Accordingly, the valve 500 is capable of positions in between the open position and the closed position, wherein the flow of fluid within the tube 400 is adjustable to a custom setting with a plurality of flow rates.

The device 10 further including an ornamental feature 600. The ornamental feature 600 configured for receipt of the tube 400 second end 402 so as to allow fluid to flow out of the second end 402 and over the ornamental feature 600. Accordingly, the ornamental feature 600 including a bore 601 extending through the ornamental feature 600 and having a size and a shape configured for receipt of the second end 402 of the tube 400. The ornamental feature 600 is generally depicted as a stacked rock formation or rock, but this ornamental feature 600 can be any decorative structure.

The device 10 generally provided in a size for placement within a traditional potted plant and wherein the device 10 functions as the standalone water feature of the present disclosure. The device 10 is assembled by a user and placed within the plant structure, wherein a user will add a fluid, such as water, to the bucket 100. Upon operation of the pump 300, the fluid within the bucket 100 is directed through the outlet 301 of the pump 300 and into the first end 401 of the tube 400 wherein the fluid will exit at the second end 402 and over the ornamental feature 600.

In use of the device 10, the user will insert the bucket 100 into a pot with soil, fill the interior 104 with a fluid, such as, water, disguise the screen cover 200 with gravel, rocks, and plants or other material, power on the device 10 though operation of the pump 300 to move the fluid within the tube 400, and adjust the valve 500 though the valve handle 501 to a desired rate of flow over the ornamental feature 600.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. An assembly configured for placement into a potted pot to provide a decorative water feature, the assembly comprising:
a bucket, the bucket having a bottom side, a plurality of sidewalls coupled to the bottom side, an upper side, and an interior space defined by the bottom side and plurality of sidewalls, wherein the bucket is configured to receive and hold a fluid;
a pump, the pump received in the interior space of the bucket, the pump including a power source and an outlet, the pump configured to move a fluid within the bucket;
a screen cover, the screen cover positioned on the upper side and having a plurality of apertures allowing access to the interior and a central aperture, the central aperture having a size corresponding to the size of a fluid transfer tube;
the fluid transfer tube having a first end coupled to the outlet and a second end extending through the central aperture;
a valve, the valve positioned at an exterior of bucket coupled to the fluid transfer tube and having a handle configured to adjust a flow of a fluid within the fluid transfer tube; and
an ornamental feature, the ornamental feature having a bore, the bore sized and shaped for receipt on the fluid transfer tube, the ornamental feature configured for resting on the screen cover during use.

2. The assembly as in claim 1, wherein the upper side includes a lip, the lip extending a circumference of the upper side and configured to provide resting support for the screen cover.

3. The assembly as in claim 2, wherein the upper side includes a notch, the notch having a size and a shape configured for the receipt of a cord for the power source.

4. The assembly as in claim 1, wherein the pump includes an attachment surface, the attachment surface configured to secure the pump at the bottom side of the bucket.

5. The assembly as in claim 1, wherein the ornamental feature is a rock.

6. A water feature for potted plants, the water feature comprising:
a bucket, the bucket having an interior configured for retaining a fluid;
a screen cover, the screen cover received on the bucket and having a plurality of apertures to allow for the flow of the fluid through the screen cover and into the bucket interior;
a submersible pump, the submersible pump received in the bucket interior in fluid coupling with the fluid in the bucket interior, the submersible pump including a power source and an outlet;
a fluid transfer tube, the fluid transfer tube having a first end and a second end opposite the first end, a distance between the first end and the second end defining a length of the fluid transfer tube, the first end coupled to the outlet and the second end extending through at least one aperture of the screen cover;
a valve, the valve adjacent to the second end of the fluid transfer tube and in fluid coupling with fluid within the transfer tube, the valve including a handle, the handle configured to adjust a flow rate of the fluid within the fluid transfer tube; and
an ornamental feature, the ornamental feature having a bore, the bore sized for receipt over the fluid transfer tube, wherein the second end of the fluid transfer tube is received within the bore.

7. The water feature as in claim 6, wherein the bucket includes an upper side, the upper side having a lip, the lip configured to provide a resting surface for the screen cover.

8. The water feature as in claim 7, wherein the lip extends a continuous circumference of the upper side.

9. The water feature as in claim 7, wherein the upper side includes a notch, the notch having a size and a shape configured for the receipt of a cord for the power source.

10. The water feature as in claim 6, wherein the pump includes an attachment surface, the attachment surface configured to secure the pump at a bottom side of the bucket interior.

11. The water feature as in claim 6, wherein the ornamental feature is a rock.

12. The water feature as in claim 6, wherein the feature is provided in a cohesive standalone assembly.

13. A standalone water fountain feature configured for placement into a potted pot to provide a decorative water feature within the potted plant, the water fountain feature comprising:
a bucket, the bucket having a frustoconical shape with a circular bottom side, a sidewall coupled to the circular bottom side having an upper side opposite the bottom side, and an interior space defined by the bottom side and sidewall, wherein the bucket is configured to receive and hold a fluid;
a pump, the pump received in the interior space of the bucket, the pump including a power source and an outlet, the pump configured to move a fluid within the bucket;
a screen cover, the screen cover positioned on the upper side and having a plurality of apertures allowing access to the interior and a central aperture, the central aperture having a size corresponding to the size of a fluid transfer tube;
the fluid transfer tube having a first end coupled to the outlet and a second end extending through the central aperture;
a valve, the valve coupled to the fluid transfer tube and having a handle configured to adjust a flow of a fluid within the fluid transfer tube; and
an ornamental feature, the ornamental feature having a bore, the bore sized and shaped for receipt on the fluid transfer tube, the ornamental feature configured for resting on the screen cover during use.

14. The water fountain feature as in claim 13, wherein the bucket upper side includes a lip, the lip configured to provide a resting surface for the screen cover.

15. The water fountain feature as in claim 14, wherein the lip extends a continuous circumference of the upper side.

16. The water fountain feature as in claim 13, wherein the upper side includes a notch, the notch having a size and a shape configured for the receipt of a cord for the power source.

17. The water fountain feature as in claim 13, wherein the pump includes an attachment surface, the attachment surface configured to secure the pump at the bottom side of the bucket interior.

18. The water fountain feature as in claim 13, wherein the ornamental feature is a rock.

19. The water fountain feature as in claim 13, wherein the feature is provided in a cohesive standalone assembly.
